(19) United States
(12) Patent Application Publication
(10) Pub. No.: US 2025/0355395 A1
(43) Pub. Date: Nov. 20, 2025

(54) IMAGE READING DEVICE, IMAGE FORMING SYSTEM, AND STORAGE MEDIUM

(71) Applicant: Konica Minolta, Inc., Tokyo (JP)

(72) Inventors: Shinobu KONNO, Tokyo (JP); Ayaka SUZUKI, Tokyo (JP)

(21) Appl. No.: 19/203,839

(22) Filed: May 9, 2025

(30) Foreign Application Priority Data
May 16, 2024 (JP) 2024-079918

(51) Int. Cl. G03G 15/00

(52) U.S. Cl. CPC G03G 15/6529; G03G 15/5054

(57) ABSTRACT

An image reading device that reads image information of a sheet after image formation includes the following. An image reader is configured to be capable of moving in a sheet width direction orthogonal to a sheet conveyance direction and to read the image information of the sheet. A first conveyor is provided on an upstream side of the image reader in the sheet conveyance direction and conveys the sheet. A second conveyor is provided on a downstream side of the image reader in the sheet conveyance direction and conveys the sheet. A hardware processor, in switching from a convey state in which the first conveyor and the second conveyor cooperate to convey a same sheet to a stopped state in conveyance of the sheet, stops the first conveyor and then stops the second conveyor.

### CROSS REFERENCE TO RELATED APPLICATIONS

The present invention claims priority under 35 U.S.C. § 119 to Japanese Patent Application No. 2024-079918, filed on May 16, 2024, the entire content of which is incorporated herein by reference.

### BACKGROUND OF THE INVENTION

### Technical Field

The present invention relates to an image reading device, an image forming system, and a storage medium.

### Description of Related Art

Conventionally, there have been known image reading devices that can reduce a possibility that a sheet jam occurs while enabling an image reading means to read image information on a sheet by moving in a width direction (see, for example, Japanese Unexamined Patent Publication No. 2021-182686).

An image reading device is known in which positions of a colorimeter and a sheet are stabilized by a guide plate that guides the sheet and an opposing member that presses a reference plane of the colorimeter via the sheet to bring the sheet into contact with the reference plane (see, for example, Japanese Unexamined Patent Publication No. 2018-170696).

In the image reading device disclosed in Japanese Unexamined Patent Publication No. 2021-182686, an upstream guide shutter and a downstream guide shutter are provided to reduce the possibility of occurrence of the jam. In the image reading device, when image information on the sheet is read by the image reading means, each guide shutter is operated in a double-door opening manner. For this reason, there is a possibility that a posture of the sheet with respect to the image reading means is not stable, and reading accuracy of the image reading means is lowered.

Since the image reading device disclosed in Japanese Unexamined Patent Publication No. 2018-170696 reads only a patch image formed in a central portion of the sheet, it is not assumed that the colorimeter is moved in the width direction. Therefore, in the image reading device, when the colorimeter is moved in the width direction in order to read the patch image formed on a portion other than the central portion of the sheet, there is a possibility that wrinkle occurs on the sheet and a failure occurs in abutting of the sheet on a reference plane.

### SUMMARY OF THE INVENTION

An object of the present invention, which has been made in consideration of the above-described problem, is to provide an image reading device, an image forming system and a storage medium capable of improving reading accuracy by an image reading section moving in a width direction of a sheet.

To achieve at least one of the abovementioned objects, according to an aspect of the present invention, an image reading device reflecting one aspect of the present invention is an image reading device that reads image information of a sheet after image formation, the image reading device including:
an image reader that is configured to be capable of moving in a sheet width direction orthogonal to a sheet conveyance direction and to read the image information of the sheet;
a first conveyor that is provided on an upstream side of the image reader in the sheet conveyance direction and conveys the sheet;
a second conveyor that is provided on a downstream side of the image reader in the sheet conveyance direction and conveys the sheet; and
a hardware processor that, in switching from a convey state in which the first conveyor and the second conveyor cooperate to convey a same sheet to a stopped state in conveyance of the sheet, stops the first conveyor and then stops the second conveyor.

According to another aspect of the present invention, an image forming system includes:
an image forming apparatus that forms an image on the sheet; and
the image reading device according to claim 1 that is arranged on the downstream side in the sheet conveyance direction with respect to the image forming apparatus.

According to another aspect of the present invention, a non-transitory computer-readable storage medium storing a program that is executed on a computer of an image reading device that reads image information of a sheet after image formation, the device including, an image reader that is configured to be capable of moving in a sheet width direction orthogonal to a sheet conveyance direction and to read the image information of the sheet, a first conveyor that is provided on an upstream side of the image reader in the sheet conveyance direction and conveys the sheet, and a second conveyor that is provided on a downstream side of the image reader in the sheet conveyance direction and conveys the sheet, wherein the program is configured to control the computer to perform,
in switching from a convey state in which the first conveyor and the second conveyor cooperate to convey a same sheet to a stopped state in conveyance of the sheet, stopping the first conveyor and then stopping the second conveyor.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic side view of an image forming system;

FIG. 2 is a block diagram showing a functional configuration of the image forming system;

FIG. 3A is a top view of a portion indicated by A in FIG. 1;

FIG. 3B is a side view of a portion indicated by A in FIG. 1;

FIG. 4 is a diagram illustrating an example of a chart image;

FIG. 5A is a diagram illustrating an example of a guide plate of an image reading section;

FIG. 5B is a diagram illustrating an example of the guide plate and a wheel of the image reading section;

FIG. 5C is a diagram illustrating an example of the guide plate and the wheel of the image reading section;

FIG. 6 is a flowchart of a control procedure of image reading processing;

FIG. 7 is a flowchart illustrating a control procedure of reading preprocessing;

FIG. 8 is a flowchart illustrating a control procedure of odd-number row reading processing;

FIG. 9 is a flowchart illustrating a control procedure of even-number row reading processing;

FIG. 10A is a diagram illustrating an example in which an edge detector detects a leading edge of a sheet;

FIG. 10B is a diagram illustrating an example in which the image reading section is moved to a reading start position of an odd-numbered row;

FIG. 10C is a view showing an example in which the image reading section is moved to a retreat position;

FIG. 10D is a diagram illustrating an example in which the sheet is conveyed by one row of a patch column;

FIG. 10E is a diagram illustrating an example in which the image reading section is moved to the reading start position of an even-numbered row; and

FIG. 10F is a diagram illustrating an example in which an image reading section is moved to the retreat position after reading of a patch is completed.

### DETAILED DESCRIPTION

Hereinafter, one or more embodiments of the present invention will be described with reference to the drawings. However, the scope of the invention is not limited to the disclosed embodiments.

Hereinafter, an image reading device and an image forming system according to an embodiment of the present invention will be described in detail with reference to the drawings. Note that the present invention is not limited to the examples illustrated in the drawings.

### [Configuration of Image Forming System]

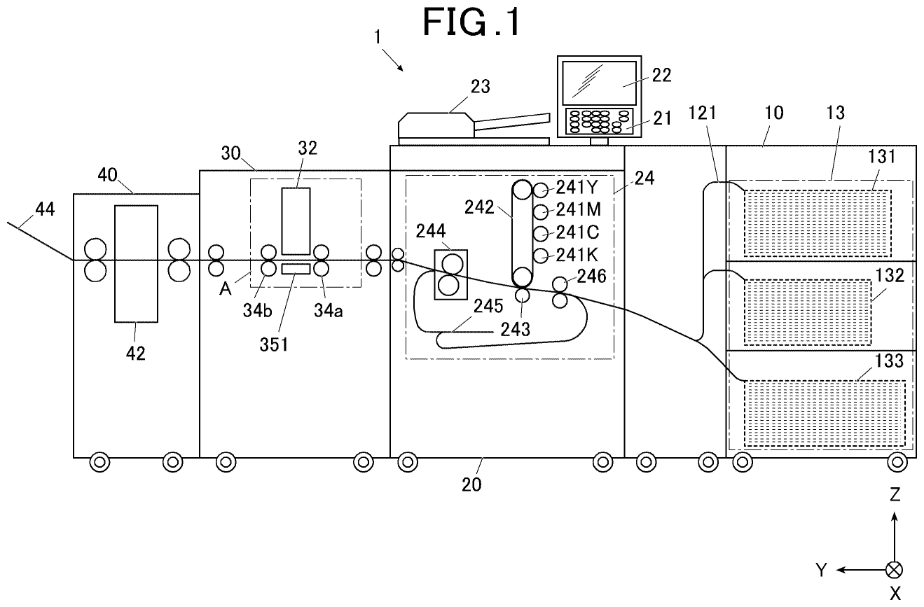

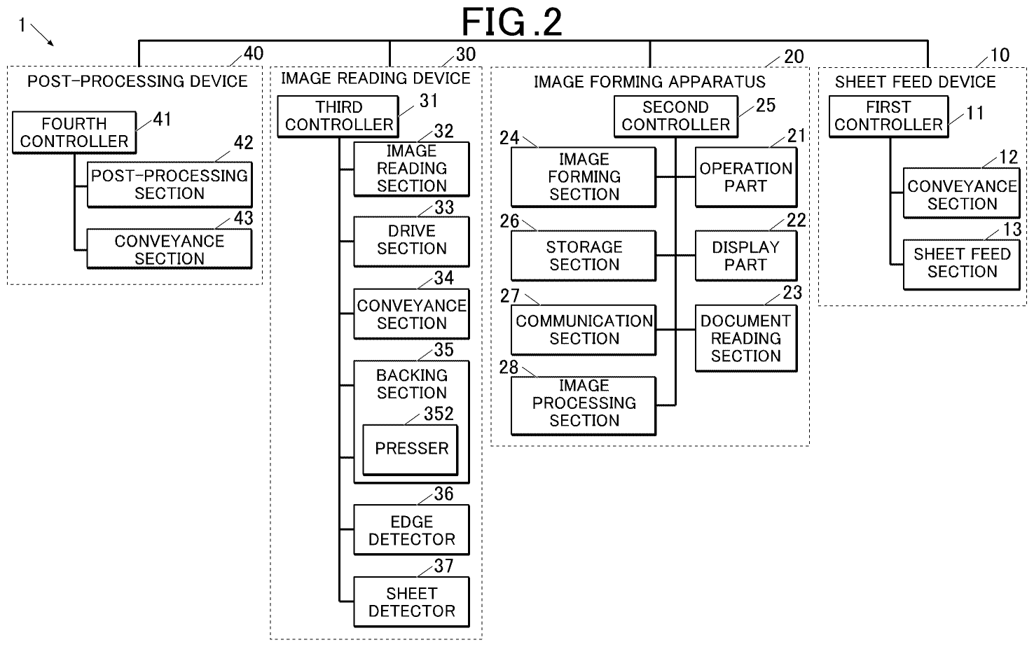

FIG. 1 is a side view illustrating a schematic configuration of an image forming system 1. FIG. 2 is a block diagram illustrating a functional configuration of the image forming system 1.

Hereinafter, an X direction, a Y direction, and a Z direction refer to directions illustrated in FIG. 1. Furthermore, in the following description, the X direction, the Y direction, and the Z direction are referred to as a sheet width direction, a sheet conveyance direction, and an up-down direction, respectively.

As illustrated in FIG. 1 and FIG. 2, the image forming system 1 includes a sheet feed device 10, an image forming apparatus 20, an image reading device 30, and a post-processing device 40. The sheet feed device 10, the image forming apparatus 20, the image reading device 30, and the post-processing device 40 are disposed in order toward a downstream side in a sheet conveyance direction.

Therefore, sheets are continuously conveyed from the sheet feed device 10 to the post-processing device 40 via the image forming apparatus 20 and the image reading device 30.

The sheet feed device 10, the image forming apparatus 20, the image reading device 30, and the post-processing device 40 are connected to each other so as to be capable of data communication.

### (Sheet Feed Device)

The sheet feed device 10 supplies stored sheets to the image forming apparatus 20. The sheet feed device 10 includes a first controller 11, a conveyance section 12, and a sheet feed section 13.

The controller 11 includes a central processing unit (CPU), a read only memory (ROM), and a random access memory (RAM).

The CPU of the first controller 11 reads various processing programs stored in the ROM, deploys the programs in the RAM, and centrally controls the operations of the respective units of the sheet feed device 10 according to the deployed programs. For example, the first controller 11 conveys a sheet from any one of sheet feed trays 131 to 133 of the sheet feed section 13 to the image forming apparatus 20 according to a job.

The conveyance section 12 includes a conveyance path 121 and conveyance rollers (not illustrated). The conveyance path 121 connects the sheet feed section 13 to the image forming apparatus 20. The conveyance roller conveys the sheet to the conveyance path 121. The sheet feed section 13 includes sheet feed trays 131 to 133 that store the sheets according to predetermined types, sizes, and the like of sheets.

### (Image Forming Apparatus)

The image forming apparatus 20 is located on the downstream side of the sheet feed device 10 in the sheet conveyance direction and on an upstream side of the image reading device 30 in the sheet conveyance direction. The image forming apparatus 20 acquires image data by reading an image from a document or receiving image data from an external device (not illustrated). The image forming apparatus 20 forms the image on the basis of the acquired image data. After the image is formed, the image forming apparatus 20 conveys the sheet to the image reading device 30.

The image forming apparatus 20 includes an operation part 21, a display part 22, a document image reading section 23, an image forming section 24, a second controller 25, a storage section 26, a communication section 27, and an image processing section 28.

The operation part 21 includes, for example, a touch screen formed so as to cover a display screen of the display part 22, and various operation buttons such as numeric buttons and a start button. The operation part 21 outputs to the second controller 25 an operation signal based on a user's operation.

The display part 22 includes a liquid crystal display (LCD) or the like. The display part 22 displays various screens according to command of display signals input from the second controller 25.

The image reading section 23 includes an automatic document feeder (ADF), a scanner, and the like. The document image reading section 23 outputs the image data obtained by reading the image of the document to the second controller 25.

The image forming section 24 forms the image on the sheet conveyed from the sheet feed device 10, based on the acquired image data. In the present embodiment, the sheet is a flat cut sheet. The image forming section 24 includes, for example, a photosensitive drum, an intermediate transfer belt 242, a secondary transfer roller 243, and a fixing section 244.

The photosensitive drums according to the present embodiment include, for example, photosensitive drums individually corresponding to respective colors of yellow (Y), magenta (M), cyan (C), and black (K). That is, the photosensitive drums include the photosensitive drums 241Y, 241M, 241C, and 241K.

The image forming section 24 uniformly charges the photosensitive drum 241Y, and then scans and exposes it with a laser beam to form an electrostatic latent image on the basis of the image data for yellow. Next, the image forming section 24 makes a yellow toner adhere to the electrostatic latent image on the photosensitive drum 241Y to perform development. The photosensitive drums 241M to 241K form images similarly to the photosensitive drum 241Y except that they handle different colors, and therefore, description thereof is omitted.

The image forming section 24 transfers the toner images in the respective colors formed on the photosensitive drums 241Y to 241K onto the intermediate transfer belt 242. The transfer onto the intermediate transfer belt 242 is a primary transfer. That is, the image forming section 24 forms a color toner image in which toner images of four colors are superimposed on the intermediate transfer belt 242.

The image forming section 24 collectively transfers the color toner image on the intermediate transfer belt 242 onto the sheet by the secondary transfer roller 243. The transfer onto the sheet is secondary transfer.

The fixing section 244 includes a heating roller and a pressure roller. The heating roller heats the sheet onto which the color toner image has been transferred. The pressure roller presses the sheet heated by the heating roller. By the heating and pressing of the fixing section 244, the color toner image is fixed onto the sheet.

The second controller 25 includes a CPU, a ROM, and a RAM. The CPU of the second controller 25 reads out various processing programs stored in the ROM, deploys the programs in the RAM, and centrally controls the operations of the respective units of the image forming apparatus 20 in accordance with the deployed programs.

The storage section 26 is a nonvolatile storage device such as a hard disk drive (HDD) or a semiconductor memory.

The storage section 26 stores data such as program data, various kinds of setting data, and image data in a manner readable and writable by the second controller 25.

The storage section 26 stores the sheet feed trays 131 to 133 and information such as basis weight, size, and type of the sheets stored therein in association with each other.

The communication section 27 transmits and receives various types of data to and from the external device such as a computer connected to a network such as a local area network (LAN) or a wide area network (WAN).

The communication section 27 includes a communication control card such as a LAN card.

The image processing section 28 performs necessary image processing on the image data before image formation. The image data includes image data stored in the storage section 26, image data obtained by reading the document by the document image reading section 23, and image data input from the external device.

The image processing section 28 transmits the image data after the image processing to the image forming section 24. The image processing includes gradation processing, halftone processing, color conversion processing, and the like. The tone processing is converting a tone value of each pixel of the image data into the tone value corrected such that density level properties of the image formed on the sheet matches target density level properties. The halftone processing is error diffusion processing, screen processing using an ordered dither method, or the like. The color conversion processing is converting each gradation value of RGB into each gradation value of CMYK. The processing of the image processing section 28 described above may be implemented by a program executed by the CPU of the controller 25.

### (Image Reading Device)

The image reading device 30 is located on the downstream side of the image forming apparatus 20 in the sheet conveyance direction and on the upstream side of the post-processing device 40 in the sheet conveyance direction.

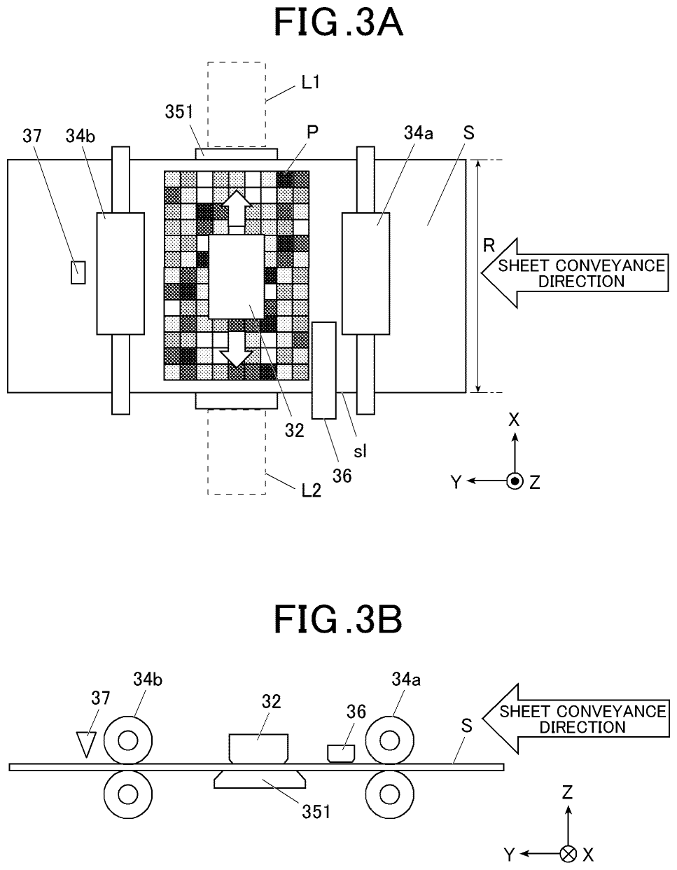

FIG. 3A shows a top view of a portion indicated by A in FIG. 1 in the image reading device 30. FIG. 3B is a side view of the portion indicated by A in FIG. 1 in the image reading device 30.

The image reading device 30 includes a third controller 31 (hardware processor), an image reading section 32 (image reader), a drive section 33, a conveyance section 34, a backing section 35, an edge detector 36, and a sheet detector 37. The image reading device 30 measures a color of a chart image on the sheet conveyed from the image forming apparatus 20 and acquires a color measurement result.

The third controller 31 includes a CPU, a ROM, and a RAM. The CPU of the third controller 31 reads out various processing programs stored in the ROM, deploys the programs in the RAM, and centrally controls the operation of each unit of the image reading device 30 according to the deployed programs.

The image reading section 32 is provided on the downstream side of the image forming apparatus 20 in a sheet conveyance path, and is capable of reading the sheet on which the image has been formed before the sheet is ejected to the outside.

The image reading section 32 is capable of reading only a partial region in a direction (sheet width direction) orthogonal to a sheet conveyance direction and parallel to a sheet surface.

The image reading section 32 is moved in the sheet width direction (X-axis direction) by the drive section 33, and reads image information of the sheet by color measurement of the chart image (adjustment image) formed on the sheet conveyed through the sheet conveyance path.

The image reading section 32 is movable from a standby position L1 to a retreat position L2 in the sheet width direction. The standby position L1 is located in a region outside a sheet passing range R on a far side in the sheet width direction (positive direction side of X-axis). The retreat position L2 is located in the region outside the sheet passing range R on a near side in the sheet width direction (negative direction side of X axis). The sheet passing range R is a conveyance region of the sheet.

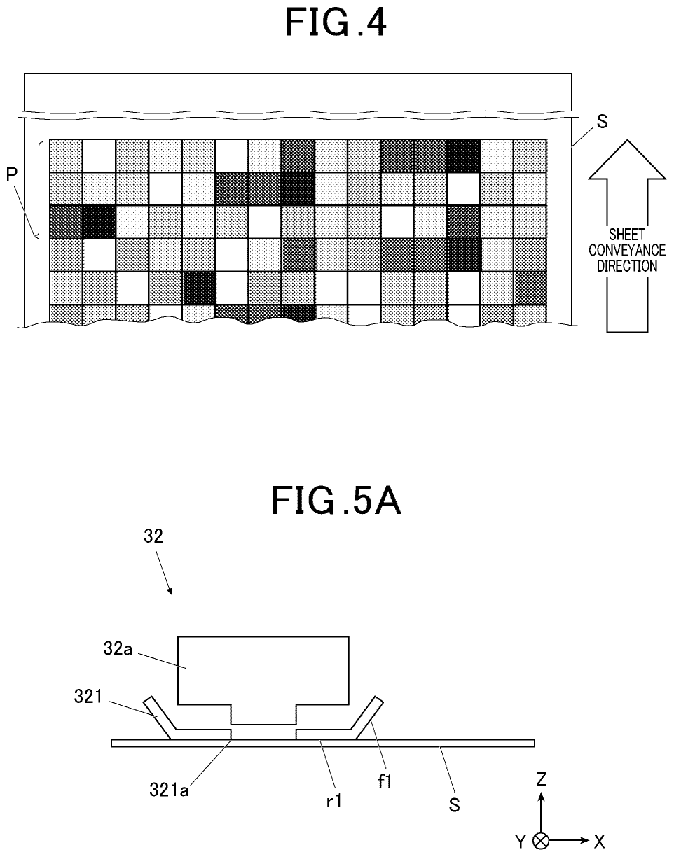

A chart image to be formed on the sheet S by the image forming apparatus 20 will be described. FIG. 4 is a diagram illustrating an example of the chart image. The chart image is a calibration chart including a plurality of patches P in which combinations of the gradation values are determined in advance.

The chart image shown in FIG. 4 is the image in which a plurality of patch columns each including a plurality of patches P arranged in a row along the sheet width direction are arranged in parallel in the sheet conveyance direction. That is, the image forming apparatus 20 forms on the sheet the two dimensionally arranged adjustment images as the image information.

In the example of FIG. 4, a case where the patch P is a square is illustrated, but the patch P may be other shapes such as a rectangular shape. The patches P have the same shape and same dimensions. Each patch P or each patch column may be formed without a gap, or the gap may be provided.

It is preferable that all of the combinations of the tone values indicating a hue of the patch P are different for each of the patches P.

The chart image is preferably formed at a position readable by the image reading section 32 in a state where the sheet S is pinched between a first conveyance roller (first conveyor) 34a and a second conveyance roller (second conveyor) 34b which will be described later. In this case, the chart image can be read in a state where an appropriate tension is applied to the sheet S by the first conveyance roller 34a and the second conveyance roller 34b, so that reading accuracy can be improved.

The chart image may not be formed at a position readable by the image reading section 32 in a state where the sheet S is nipped between the first conveyance roller 34a and the second conveyance roller 34b. The chart image may be formed at a position where an amount of waste sheet can be reduced as compared with a case where the chart image is formed at a position where the image reading section 32 can read the chart image in a state where the sheet S is nipped between the first conveyance roller 34a and the second conveyance roller 34b.

The image forming section 24 of the image forming apparatus 20 forms a chart image on one side of the sheet S. The image reading section 32 includes a spectrophotometer, and performs color measurement of (reads) each patch P of the chart image formed by the image forming section 24. Therefore, the image reading section 32 can perform color measurement with higher accuracy than the image reading section constituted by a color scanner.

The image reading section 32 individually measures all the patches P of the chart image, and outputs the results to the third controller 31. The third controller 31 compares the gradation value of each patch P defined in the image data of the chart image with the gradation value measured by the image reading section 32. Next, the third controller 31 creates a color profile by comparing these, and transmits the color profile to the image forming apparatus 20.

The second controller 25 corrects the hue with reference to the color profile when the image is formed by the image forming section 24.

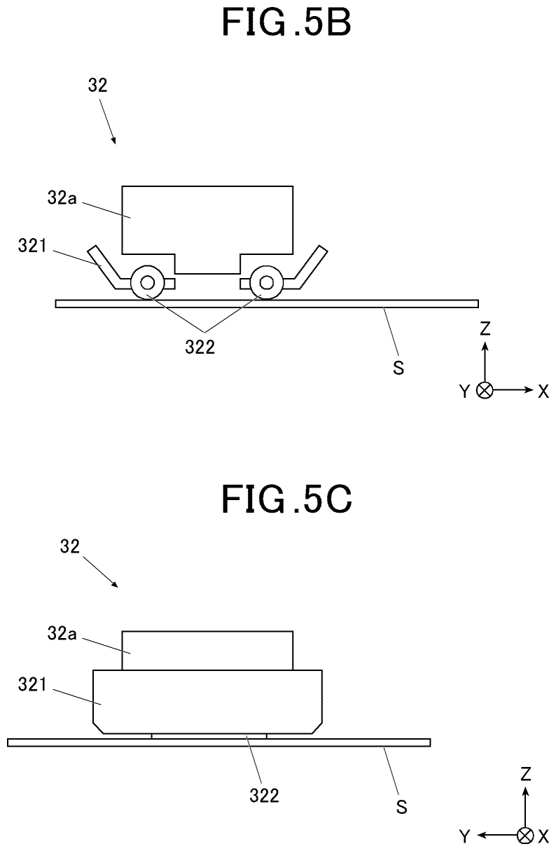

As shown in FIG. 5A, the image reading section 32 includes a guide plate 321 on a lower surface (surface in a Z-axis negative direction) of the reading main body section 32a.

The guide plate 321 is a substantially rectangular flat plate member. The guide plate 321 is provided with an opening 321a through which the spectrophotometer of the image reading section 32 can face the sheet S through the guide plate 321. The opening 321a includes, for example, a circular shape. The lower surface of the guide plate 321 is a flat surface and constitutes a color measurement reference surface r1. The guide plate 321 abuts on the sheet S at the color measurement reference surface r1. An inclined surface f1 for smoothly guiding the conveyed sheet S can be provided at a portion of the lower surface of the guide plate 321 other than the color measurement reference surface r1.

Since the image reading section 32 includes the guide plate 321, the guide plate 321 restricts lifting of the sheet when the image reading section 32 moves on the sheet in the sheet width direction, it is possible to smoothly move the image reading section 32 on the sheet.

In the image reading section 32, the reading main body section 32a and the guide plate 321 may be integrally formed.

The image reading section 32 may include a slide sheet instead of the guide plate 321.

As shown in FIG. 5B and FIG. 5C, the image reading section 32 may include the guide plate 321 and the wheel 322 on the lower surface of the reading main body section 32a. The image reading section 32 abuts on the sheet S at the wheel 322.

The wheel 322 is rotatable in the sheet width direction which is a movement direction of the image reading section 32. In a case where the image reading section 32 includes the wheel 322, the wheel 322 rotates when the image reading section 32 moves on the sheet in the sheet width direction, and thus the image reading section 32 can be smoothly moved on the sheet.

As described above, a reduction section (reducer) which is the guide plate 321 or the wheel 322 of the image reading section 32 reduces the occurrence of the jam of the sheet accompanied by the movement of the image reading section 32 by smoothly moving the image reading section 32 on the sheet. That is, the reduction section reduces sliding resistance force in the movement of the image reading section 32 in the sheet width direction. To be specific, it is preferable to provide, in the image reading section 32, such reduction section that the sliding resistance force in the movement of the image reading section 32 in the sheet width direction is within a range of one fourth to one tenth of a conveyance force of the first conveyance roller 34a and the second conveyance roller 34b.

The drive section 33 slides the image reading section 32 in the sheet width direction so that the image reading section 32 is positioned at a desired reading position when the plurality of patches P regularly arranged in the sheet width direction in the chart image formed on the sheet are individually measured by the image reading section 32. A drive source of the drive section 33 is, for example, a stepping motor or the like.

The conveyance section 34 includes a sheet conveyance path that connects the image forming apparatus 20 to the post-processing device 40, and a plurality of conveyance rollers that extend in the sheet width direction and convey the sheet on the sheet conveyance path.

The plurality of conveyance rollers include the first conveyance roller 34a (first conveyance unit) located on the upstream side of the image reading section 32 in the sheet conveyance direction, and the second conveyance roller 34b (second conveyance unit) located on the downstream side of the image reading section 32 in the sheet conveyance direction. The first conveyance roller 34a and the second conveyance roller 34b are driven by, for example, a stepping motor or the like.

The sheet conveyance force of the second conveyance roller 34b is smaller than the sheet conveyance force of the first conveyance roller 34a.

The first conveyance roller 34a and the conveyance roller located on the upstream side of the first conveyance roller 34a in the sheet conveyance direction correct inclination of the sheet S conveyed on the sheet conveyance path, as a registration operation.

It is preferable that the size of the patch P of the chart image is reduced in order to shorten the reading time by the image reading section 32, reduce the number of sheets on which the chart image is formed, and the like. Even in a case where the patch P of the chart image is relatively small in this manner, conveyance accuracy of the sheet can be improved by correcting the inclination of the sheet, so that an error can be prevented from occurring in the reading of the patch P by the image reading section 32.

The backing section 35 includes a background member (backgrounder) 351, a presser 352, and the like.

The background member 351 is provided at a position facing the position of the image reading section 32 when the color measurement of the chart image formed on the sheet S is measured. Since the background member 351 is a member serving as a background of the sheet S, the surface of the background member 351 facing the image reading section 32 is preferably white or black.

The presser 352 moves the background member 351 in the up-down direction (the Z-axis direction) under the control of the third controller 31.

Specifically, when the color measurement of the chart image formed on the sheet S is performed by the image reading section 32, the presser 352 raises and presses the background member 351 in a direction toward the image reading section 32 (Z-axis positive direction). Accordingly, the sheet S can abut the image reading section 32 by the pressed background member 351. Therefore, since the posture of the sheet S with respect to the image reading section 32 can be stabilized, the reading accuracy of the image reading section 32 can be improved.

On the other hand, when the sheet S is conveyed on the background member 351, the presser 352 lowers the background member 351 in the Z-axis negative direction to release the pressing. That is, the presser 352 retreats the background member 351 from the sheet conveyance path. Thus, the background member 351 can be prevented from obstructing the conveyance of the sheet, thus enhancing sheet conveyance performance.

The edge detector 36 is provided on the downstream side of the first conveyance roller 34a in the sheet conveyance direction and on the upstream side of the image reading section 32 in the sheet conveyance direction.

The edge detector 36 detects the position of the sheet S in the sheet width direction. More specifically, the edge detector 36 detects the position of a side edge portion s1 on one side of the sheet width direction in the sheet width direction. The edge detector 36 outputs a detection result of the position of the sheet S to the third controller 31.

The edge detector 36 is a linear image sensor such as a contact image sensor (CIS). As illustrated in FIG. 3A, the edge detector 36 is arranged so that a linear detection range is parallel to the sheet width direction and is directed toward the side of the conveyed sheet S.

The sheet detector 37 is provided on the downstream side of the second conveyance roller 34b in the sheet conveyance direction.

The sheet detector 37 detects the presence or absence of the sheet at a position downstream of the second conveyance roller 34b, which is an installation position, in the sheet conveyance direction. The sheet detector 37 outputs the detection result of the sheet S to the third controller 31.

When the sheet detector 37 detects the presence of the sheet, that is, when it is detected that the sheet is present at a position downstream of the second conveyance roller 34b in the sheet conveyance direction, the third controller 31 determines that the sheet is being nipped by the second conveyance roller 34b.

### (Post-Processing Device)

The post-processing device 40 is located on the downstream side of the image reading device 30 in the sheet conveyance direction, and performs post-processing on the sheet conveyed from the image reading device 30.

The post-processing device 40 includes a fourth controller 41, a post-processing section 42, a conveyance section 43, and a sheet ejection tray 44.

The fourth controller 41 includes a CPU, a RAM, and a ROM.

The CPU of the fourth controller 41 reads various processing programs stored in the ROM and deploys the programs in the RAM.

The fourth controller 41 comprehensively controls the operation of the post-processing device 40 in cooperation with the various programs deployed in the RAM.

The post-processing section 42 performs post-processing on the sheet conveyed from the image reading device 30. The post-processing is, for example, cutting, folding processing, perforation processing, creasing, foil stamping, varnish processing, various kinds of bookbinding, or the like.

The conveyance section 43 includes a plurality of roller pairs and conveys the sheet conveyed from the image reading device 30 to the post-processing section 42.

Next, the conveyance section 43 ejects the sheet subjected to the post-processing by the post-processing section 42 to the sheet ejection tray 44.

### [Operation of Image Forming System]

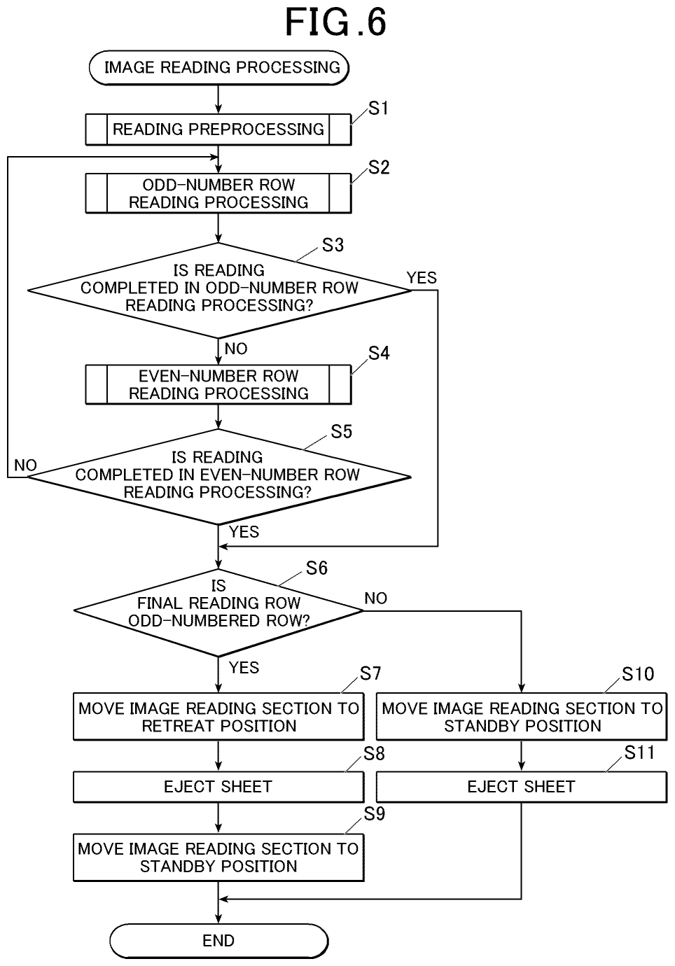

Next, operation of the image forming system 1 will be described. Image reading processing to be executed by the image reading device 30 will be described with reference to FIG. 6. FIG. 6 is a flowchart of a control procedure of the image reading processing.

### (Image Reading Processing)

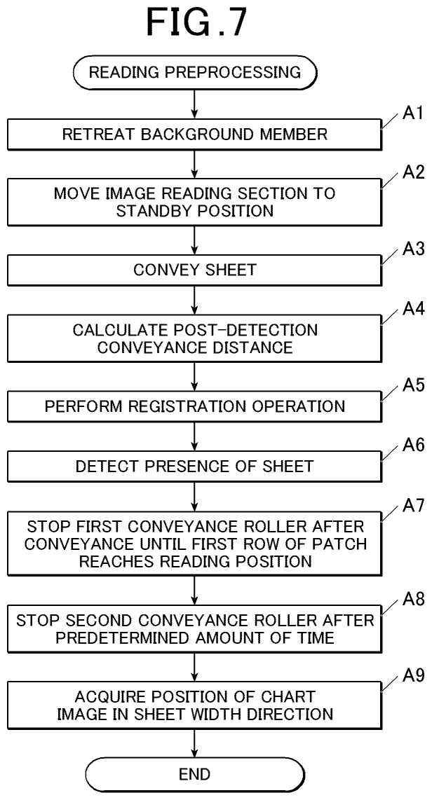

The third controller 31 of the image reading device 30 executes the reading preprocessing shown in FIG. 7 (step S1).

### (Reading Preprocessing)

The third controller 31 controls the presser 352 of the backing section 35 to lower the background member 351, thereby retreating the background member 351 from the sheet conveyance path (step A1).

Next, the third controller 31 controls the drive section 33 to move the image reading section 32 to the standby position L1 (step A2).

Next, the third controller 31 causes the conveyance section 34 to convey the sheet S, on which the chart image is formed and which is conveyed from the image forming apparatus 20, in the image reading device 30 (step A3).

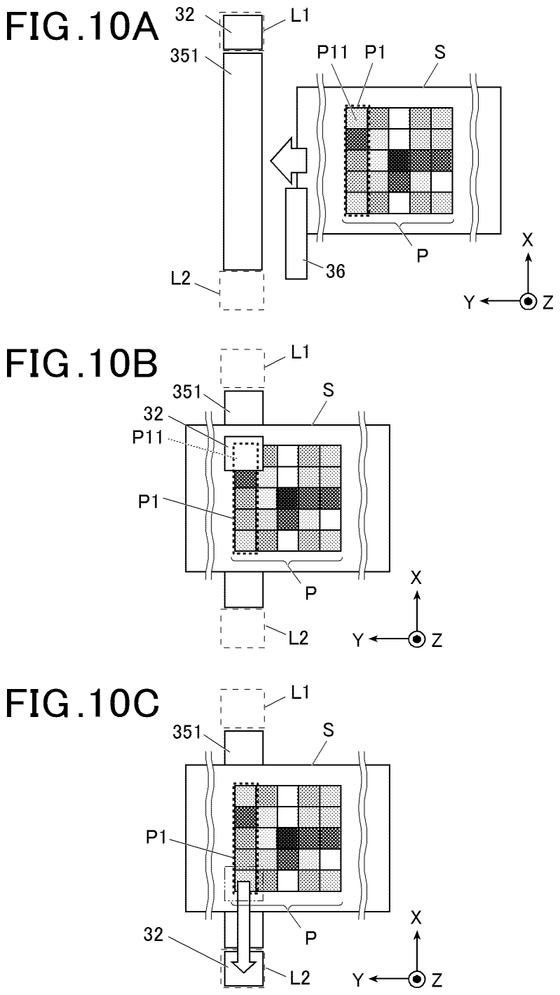

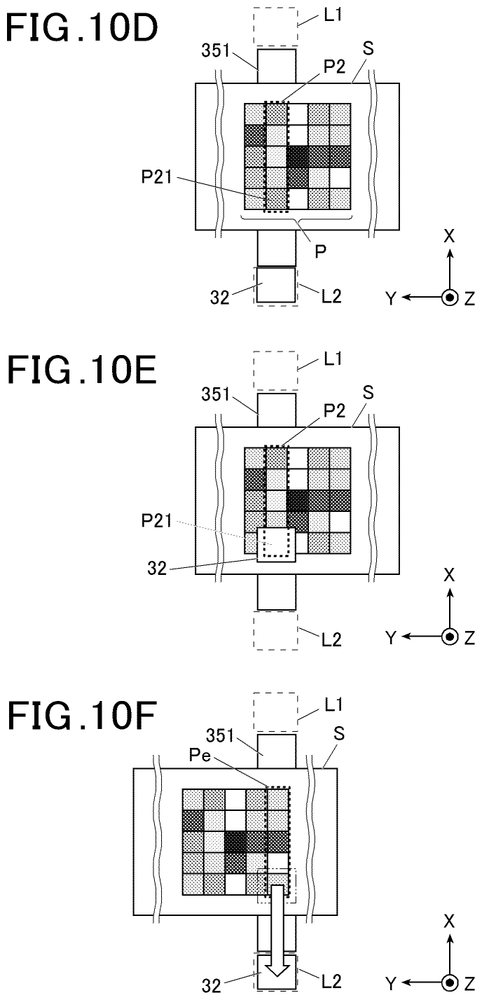

Next, the third controller 31 calculates the post-detection conveyance distance on the basis of information regarding the sheet and information regarding the chart image formed on the sheet (step A4). The information regarding the sheet includes the size of the sheet. The information regarding the chart image includes the size of the chart image, the formation position of the chart image on the sheet, and the like. The post-detection conveyance distance is a distance that a sheet is conveyed from when the presence of the sheet is detected by the sheet detector 37 until an initial row of the chart image on the sheet, which is an object to be read, reaches the reading position of the image reading section 32. The initial row of the chart image is a first row P1 of the patch P shown in FIG. 10A.

Next, when the sheet being conveyed reaches the first conveyance roller 34a, the third controller 31 executes the registration operation with the first conveyance roller 34a and the conveyance roller positioned on the upstream side of the first conveyance roller 34a in the sheet conveyance direction, to correct the inclination of the sheet S (step A5). Specifically, the third controller 31 corrects the inclination of a leading end side (the downstream side in the sheet conveyance direction) of the sheet by conveying the sheet with the conveyance roller positioned on the upstream side of the first conveyance roller 34a in the sheet conveyance direction while the first conveyance roller 34a is stopped.

Next, the third controller 31 further conveys the sheet, and acquires a result of detection by the sheet detector 37 that the sheet is present at a position downstream of the second conveyance roller 34b in the sheet conveyance direction (step A6). That is, the third controller 31 determines that the sheet is being nipped by the second conveyance roller 34b.

In step A6, the third controller 31 may determine, without using the detection result of the sheet detector 37, that the sheet is being pinched by the second conveyance roller 34b, based on the length of the sheet conveyed by the first conveyance roller 34a (feed amount of the sheet).

Next, the third controller 31 causes the first conveyance roller 34a and the second conveyance roller 34b to convey the sheet by the post-detection conveyance distance calculated in step A4. That is, the third controller 31 conveys the sheet S until the first row P1 of the patch P reaches the reading position of the image reading section 32. Thereafter, the third controller 31 stops the conveyance of the sheet by the first conveyance roller 34a (step A7).

Next, after a predetermined amount of time from the stop of the conveyance of the sheet by the first conveyance roller 34a in step A7, the third controller 31 stops the conveyance of the sheet by the second conveyance roller 34b (step A8). That is, when switching from a conveyance state in which the first conveyance roller 34a and the second conveyance roller 34b cooperate to convey the same sheet to the stopped state in the conveyance of the sheet, the third controller 31 stops the first conveyance roller 34a and then stops the second conveyance roller 34b.

The third controller 31 controls the predetermined amount of time by adjusting a number of steps of a stepper motor that is a drive source of the first conveyance roller 34a and the second conveyance roller 34b, a conveyance distance by the stepper motor, and the like.

The third controller 31 determines the predetermined amount of time based on the type of the sheet, the basis weight of the sheet, the size of the sheet, the position of the patch P in the sheet conveyance direction, the reading position of the image reading section 32, and the like. For example, when the sheet is a thick sheet in which wrinkle, waving, and the like are less likely to occur, the third controller 31 makes the predetermined amount of time shorter than that in a case of the sheet having a normal thickness. When the sheet is the sheet having a rough surface, such as a thin sheet or a rough sheet, the third controller 31 sets the predetermined amount of time to be longer than that for the normal sheet.

In this way, by stopping the conveyance of the sheet by the second conveyance roller 34b after a predetermined amount of time from the stopping of the conveyance of the sheet by the first conveyance roller 34a, it is possible to eliminate deflection of the sheet between the first conveyance roller 34a and the second conveyance roller 34b and apply an appropriate tension to the sheet.

Stopping the conveyance of the sheet by the second conveyance roller 34b after a predetermined amount of time from the stopping of the conveyance of the sheet by the first conveyance roller 34a makes it possible to apply the appropriate tension to the sheet with simpler control than applying the tension to the sheet by the difference between a conveyance speed of the first conveyance roller 34a and the conveyance speed of the second conveyance roller 34b.

As described above, the sheet conveyance force of the second conveyance roller 34b is smaller than the sheet conveyance force of the first conveyance roller 34a. Therefore, even when the conveyance of the sheet by the second conveyance roller 34b is stopped after a predetermined amount of time has elapsed from the stop of the conveyance of the sheet by the first conveyance roller 34a, the difference between the position of the patch P to be read and the reading position of the image reading section 32 can be reduced.

In steps A7 and A8, the third controller 31 may perform the following processing. To be specific, the third controller 31 causes the first conveyance roller 34a to convey the sheet by the post-detection conveyance distance. In addition, the third controller 31 causes the second conveyance roller 34b to convey the sheet longer than the post-detection conveyance distance by a distance corresponding to the tension to be applied to the sheet. Alternatively, the third controller 31 causes the second conveyance roller 34b to convey the sheet by the post-detection conveyance distance. In addition, the third controller 31 causes the first conveyance roller 34a to convey the sheet by a distance shorter than the post-detection conveyance distance by a distance corresponding to the tension to be applied to the sheet. Alternatively, the third controller 31 may determine the distance by which the first conveyance roller 34a and the second conveyance roller 34b convey the sheet after the sheet detector 37 detects the sheet, in accordance with the type, basis weight, size, and the like of the sheet.

Next, the third controller 31 acquires a result of detection of the position of the sheet S in the sheet width direction by the edge detector 36. Next, the third controller 31 acquires the position of the chart image formed on the sheet S in the sheet width direction based on the detection result of the position of the sheet S in the sheet width direction (step A9), and ends the reading preprocessing. The third controller 31 may execute step A9 next to step A5, but preferably executes step A9 while the first conveyance roller 34a and the second conveyance roller 34b are applying appropriate tensions to the sheet.

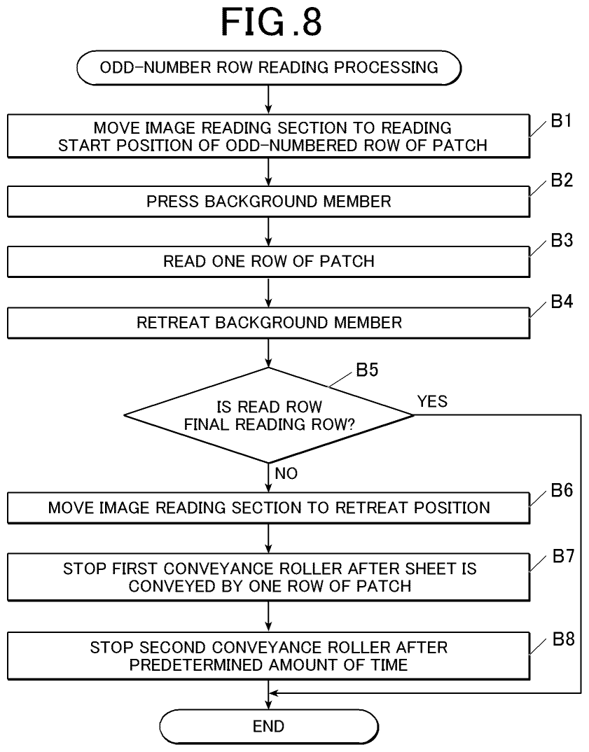

Referring back to FIG. 6, the third controller 31 executes the odd-number row reading processing illustrated in FIG. 8 (step S2).

### (Odd-Number Row Reading Processing)

The third controller 31 controls the drive section 33 to move the image reading section 32 in the sheet width direction from the standby position L1. Next, the third controller 31 moves the image reading section 32 to the reading start position of the odd-numbered row of the patch P based on the position of the chart image in the sheet width direction acquired in step A9 of the reading preprocessing (step B1).

In the example illustrated in FIG. 10B, the third controller 31 moves the image reading section 32 to a reading start position P11 of the first row P1 of the patch P.

Next, the third controller 31 controls the presser 352 to raise and press the background member 351 in a direction toward the image reading section 32 (Z-axis positive direction) (step B2). Thus, the third controller 31 causes the sheet S to be in contact with the image reading section 32 by the pressed background member 351.

Next, the third controller 31 causes the image reading section 32 to read one row of the patch P (step B3).

In step B3, after reading the initial patch P in one row of the patch P by the image reading section 32, the third controller 31 moves the image reading section 32 to the reading position of the next patch P. The next patch P is the patch P adjacent to the initial patch P in the sheet width direction.

Next, the third controller 31 reads the next patch P by the image reading section 32. Thereafter, the third controller 31 repeats the movement of the image reading section 32 in the sheet width direction and the reading of the patch P by the image reading section 32 until one row of the patch P is read.

The third controller 31 controls the movement distance of the image reading section 32 by adjusting the number of steps of a stepping motor which is a drive source of the drive section 33, the movement distance by the stepping motor, and the like in the movement of the image reading section 32 to the reading position of the adjacent patch P in the sheet width direction.

As described above, the image reading section 32 moves in the sheet width direction and reads the chart image, which is the image information of the sheet, in the stop state in the conveyance of the sheet.

In step B3, the image reading section 32 moves in the sheet width direction with the sheet S nipped between the image reading section 32 and the background member 351 pressed by the presser 352.

In step B3, when the third controller 31 moves the image reading section 32 in the sheet width direction, the third controller 31 may make the pressing force to press the background member 351 against the image reading section 32 by the presser 352 smaller than that at the time of reading the patch P by the image reading section 32. Thus, the occurrence of the wrinkle, the waving, and the like of the sheet due to the movement of the image reading section 32 can be suppressed. Furthermore, the amount of processing time is shorter than the processing of lowering the background member 351 and retreating the background member 351 from the sheet conveyance path, and the posture and position of the sheet can be stabilized.

In steps B2 and B3, the third controller 31 may execute the following processing. Specifically, the third controller 31 determines, based on the type, thickness, basis weight, and the like of the sheet, whether to press the background member 351 by the presser 352 to bring the sheet S into contact with the image reading section 32. For example, in the case of a sheet in which the wrinkle, the waving, or the like occurs with the movement of the image reading section 32 in the sheet width direction, the third controller 31 executes the movement of the image reading section 32 in the sheet width direction and the reading of the patch P by the image reading section 32 without pressing the background member 351 by the presser 352.

In other words, the third controller 31 determines, based on the type and/or the basis weight of the sheet, whether to cause the sheet to be in a state of being sandwiched between the image reading section 32 and the background member 351 pressed by the presser 352 or in a state of not pressing the background member 351 by the presser 352, when moving the image reading section 32 in the sheet width direction.

Next, the third controller 31 controls the presser 352 to lower the background member 351, thereby retreating the background member 351 from the sheet conveyance path (step B4).

Next, the third controller 31 determines whether the row of the patch P read in step B3 is the last row to be read on the sheet (final reading row) (step B5).

When the row of the patch P read in step B3 is not the final reading row on the sheet (step B5; NO), as illustrated in FIG. 10C, the third controller 31 controls the drive section 33 to move the image reading section 32 to the retreat position L2 (step B6).

Next, as illustrated in FIG. 10D, the third controller 31 causes the first conveyance roller 34a and the second conveyance roller 34b to convey the sheet by one row of the patch P. Next, the third controller 31 conveys the sheet by one row of the patch P and then stops the conveyance of the sheet by the first conveyance roller 34a (step B7).

Next, after a predetermined amount of time from the stop of the conveyance of the sheet by the first conveyance roller 34a in step B7, the third controller 31 stops the conveyance of the sheet by the second conveyance roller 34b (step B8) and ends the odd-number row reading processing.

The third controller 31 controls the predetermined amount of time by adjusting a number of steps of a stepper motor that is a drive source of the first conveyance roller 34a and the second conveyance roller 34b, a conveyance distance by the stepper motor, and the like.

On the other hand, in a case in which the row of the patch P read in step B3 is the final reading row of the sheet (step B5; YES), the third controller 31 ends the odd-number row reading processing.

Returning to FIG. 6, the third controller 31 determines whether reading of the chart image has been completed in the odd-number row reading processing, that is, whether the final reading row of the sheet has been read in the odd-number row reading processing (step S3).

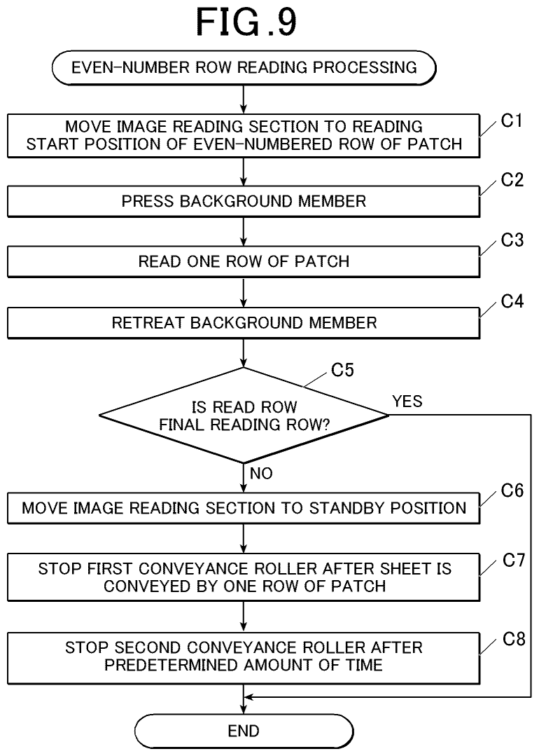

When the reading of the chart image is not completed in the odd-number row reading processing (step S3; NO), the third controller 31 executes even-number row reading processing illustrated in FIG. 9 (step S4).

### (Even-Number Row Reading Processing)

The third controller 31 controls the drive section 33 to move the image reading section 32 from the retreat position L2 in the sheet width direction. Next, the third controller 31 moves the image reading section 32 to the reading start position of the even-numbered row of the patch P based on the position of the chart image in the sheet width direction acquired in step A9 of the reading preprocessing (step C1).

In the example illustrated in FIG. 10E, the third controller 31 moves the image reading section 32 to a reading start position P21 of a second row P2 of the patch P.

Next, the third controller 31 executes steps C2 to C5 similar to steps B2 to B5.

When the row of the patch P read in step C3 is not the final reading row on the sheet (step C5; NO), the third controller 31 controls the drive section 33 to move the image reading section 32 to the standby position L1 (step C6).

Next, the third controller 31 executes steps C7 and C8 similar to steps B7 and B8, and ends the even-number row reading processing.

On the other hand, when the row of the patch P read in step C3 is the final reading row on the sheet (step C5; YES), the third controller 31 ends the even-number row reading processing.

Returning to FIG. 6, the third controller 31 determines whether the reading of the chart image has been completed in the even-number row reading processing, that is, whether the final reading row of the sheet has been read in the even-number row reading processing (step S5).

When the reading of the chart image is not completed in the even-number row reading processing (step S5; NO), the third controller 31 shifts the image reading process to step S2 and continues the reading of the chart image.

On the other hand, when the reading of the chart image is completed in the odd-number row reading processing (step S3; YES), or when the reading of the chart image is completed in the even-number row reading processing (step S5; YES), the third controller 31 determines whether the final reading row of the sheet is the odd-numbered row (step S6).

In a case where the reading final row of the sheet is the odd-numbered row (step S6; YES), as illustrated in FIG. 10F, the third controller 31 controls the drive section 33 to move the image reading section 32 from the reading position of the final patch P of a final reading row Pe to the retreat position L2 (step S7).

Next, the third controller 31 causes the conveyance section 34 including the first conveyance roller 34a and the second conveyance roller 34b to convey the sheet S, thereby discharging the sheet S to the post-processing device 40 (step S8).

Next, the third controller 31 controls the drive section 33 to move the image reading section 32 from the retreat position L2 to the standby position L1 (step S9), and ends the image reading process.

On the other hand, in a case where the final reading row of the sheet is the even-numbered row (step S6; NO), the third controller 31 controls the drive section 33 to move the image reading section 32 from the reading position of the final patch P of the final reading row to the standby position L1 (step S10).

Next, the third controller 31 conveys the sheet S by the conveyance section 34 including the first conveyance roller 34a and the second conveyance roller 34b to eject the sheet S to the post-processing device 40 (step S11), and ends the image reading processing.

### Effects

As described above, the image reading device 30 of the present embodiment is the image reading device that reads image information of the sheet S after image formation.

The image reading device 30 includes the image reading section 32 that is movable in the sheet width direction orthogonal to the sheet conveyance direction and reads the image information of the sheet.

The image reading device 30 includes a first conveyance means (first conveyance roller 34a) which is provided on the upstream side in the sheet conveyance direction from the image reading section 32 and conveys the sheet.

The image reading device 30 includes a second conveyance means (second conveyance roller 34b) that is provided on the downstream side of the image reading section 32 in the sheet conveyance direction and conveys the sheet.

The image reading device 30 includes a controller (third controller 31) that, when switching from a conveyance state in which the first conveyance means and the second conveyance means cooperate to convey the same sheet to a stopped state in which the conveyance of the sheet is stopped, stops the second conveyance means after stopping the first conveyance means.

Therefore, it is possible to eliminate the bending of the sheet between the first conveyance roller 34a and the second conveyance roller 34b and apply an appropriate tension to the sheet, thereby stabilizing the position of the sheet with respect to the image reading section 32. Thus, the reading accuracy of the image reading section 32 that moves in the width direction of the sheet can be improved.

In the image reading device 30 of the present embodiment, the image reading section 32 moves in the sheet width direction and reads the image information of the sheet in the stopped state in the conveyance of the sheet S.

Therefore, since the image reading section 32 can read image information from the stopped sheet, it is possible to read image information with high accuracy.

In the image reading device 30 according to the present embodiment, the controller (third controller 31) determines, based on the type and/or basis weight of the sheet S, the time from when the first conveyance means (first conveyance roller 34a) is stopped to when the second conveyance means (second conveyance roller 34b) is stopped.

Therefore, it is possible to set the appropriate amount of time according to the type and/or the basis weight of the sheet.

The image reading device 30 of the present embodiment includes the presser 352 that presses the background member 351 provided at the position facing the image reading section 32 toward the image reading section 32.

The image reading section 32 moves in the sheet width direction in a state where the sheet S is sandwiched between the image reading section 32 and the background member 351 pressed by the presser 352.

Therefore, it is possible to stabilize the posture and position of the sheet during the movement of the image reading section 32 in the sheet width direction.

In the image reading device 30 of the present embodiment, the controller (third controller 31) determines whether the sheet is sandwiched between the background member 351 pressed by the presser 352 and the image reading section 32 or the background member 351 is not pressed by the presser 352 when the image reading section 32 is moved in the sheet width direction based on the type and/or basis weight of the sheet S.

Therefore, in a case the sheet used is the sheet in which the wrinkle, the waving, and the like are generated when the image reading section 32 is moved in the sheet width direction in a state where the sheet is sandwiched between the background member 351 pressed by the presser 352 and the image reading section 32, it is possible to prevent the wrinkle, the waving, and the like from being generated in the sheet by not pressing the background member 351.

In the image reading device 30 according to the present embodiment, the image reading section 32 includes the reduction section (guide plate 321 and wheel 322) that reduces the sliding resistance in the movement in the sheet width direction at a portion that comes into contact with the sheet S.

Therefore, by smoothly moving the image reading section 32 on the sheet, the occurrence of the jam of the sheet due to the movement of the image reading section 32 is reduced.

In the image reading device 30 according to the present embodiment, the controller (third controller 31) makes the pressing force of the presser 352 smaller than the pressing force with which the image reading section 32 reads the image information of the sheet, thereby reducing the sliding resistance in the movement of the image reading section 32 in the sheet width direction.

Therefore, it is possible to suppress the occurrence of the wrinkle, the waving, and the like of the sheet due to the movement of the image reading section 32. Furthermore, the amount of processing time is shorter than the processing of lowering the background member 351 and retreating the background member 351 from the sheet conveyance path, and the posture and position of the sheet can be stabilized.

In the image reading device 30 according to the present embodiment, the first conveyance means (first conveyance roller 34a) corrects the inclination of the sheet S.

Therefore, even when the patch P of the chart image is relatively small, the conveyance accuracy of the sheet can be improved by correcting the inclination of the sheet by the first conveyance roller 34a, so that an error can be prevented from occurring in the reading of the patch P by the image reading section 32.

In the image reading device 30 according to the present embodiment, the conveyance force of the first conveyance means (first conveyance roller 34a) is greater than the conveyance force of the second conveyance means (second conveyance roller 34b).

Therefore, even in a case where the conveyance of the sheet by the second conveyance roller 34b is stopped after a predetermined amount of time from the stop of the conveyance of the sheet by the first conveyance roller 34a, the difference between the position of the patch P to be read and the reading position of the image reading section 32 can be reduced.

In the image reading device 30 of the present embodiment, the image reading section 32 includes a spectrophotometer.

Thus, it is possible to perform color measurement with higher accuracy than the color scanner.

The image forming system 1 of the present embodiment includes an image forming apparatus 20 that forms the image on the sheet S, and the image reading device 30 that is disposed on the downstream side of the image forming apparatus 20 in the sheet conveyance direction.

The image forming apparatus 20 forms, on the sheet, two dimensionally arranged adjustment images (chart images) as image information.

Therefore, it is possible to improve the reading accuracy of the image reading section 32 which moves in the sheet width direction in order to read the two dimensionally arranged adjustment images.

The description in the above embodiment is an example of the image reading device and the image forming system according to the present invention, and the present invention is not limited to this.

For example, in the above-described embodiment, the image reading device 30 includes one image reading section 32, but is not limited thereto. The image reading device 30 may include a plurality of image reading sections 32.

It is needless to say that the detailed configuration and the detailed operation of each of the constituent elements of the image reading device 30 and the image forming system 1 in the embodiment described above can be appropriately modified without departing from the spirit and scope of the present invention.

Although embodiments of the present invention have been described and shown in detail, the disclosed embodiments are made for purposes of illustration and example only and not limitation. The scope of the present invention should be interpreted by terms of the appended claims.

What is claimed is:

1. An image reading device that reads image information of a sheet after image formation, the image reading device comprising:
an image reader that is configured to be capable of moving in a sheet width direction orthogonal to a sheet conveyance direction and to read the image information of the sheet;
a first conveyor that is provided on an upstream side of the image reader in the sheet conveyance direction and conveys the sheet;
a second conveyor that is provided on a downstream side of the image reader in the sheet conveyance direction and conveys the sheet; and
a hardware processor that, in switching from a convey state in which the first conveyor and the second conveyor cooperate to convey a same sheet to a stopped state in conveyance of the sheet, stops the first conveyor and then stops the second conveyor.

2. The image reading device according to claim 1, wherein the image reader reads the image information by moving in the sheet width direction in the stopped state.

3. The image reading device according to claim 1, wherein the hardware processor determines, based on a type and/or a basis weight of the sheet, an amount of time from when the first conveyor is stopped to when the second conveyor is stopped.

4. The image reading device according to claim 1,
further comprising a presser that presses a backgrounder provided at a position facing the image reader toward the image reader,
wherein the image reader moves in the sheet width direction in a state where the sheet is sandwiched between the image reader and the backgrounder pressed by the presser.

5. The image reading device according to claim 4, wherein the hardware processor determines, based on a type and/or a basis weight of the sheet, whether to set a state in which the sheet is sandwiched between the backgrounder pressed by the presser and the image reader or a state in which the backgrounder is not pressed by the presser when the image reader is moved in the sheet width direction.

6. The image reading device according to claim 1, wherein the image reader includes a reducer configured to reduce a sliding resistance in a movement in the sheet width direction in a portion which abuts on the sheet.

7. The image reading device according to claim 4, wherein the hardware processor reduces a sliding resistance in a movement of the image reader in the sheet width direction by setting a pressing force of the presser to be smaller than the pressing force when the image reader reads the image information.

8. The image reading device according to claim 1, wherein the first conveyor corrects an inclination of the sheet.

9. The image reading device according to claim 1, wherein a conveyance force of the first conveyor is greater than the conveyance force of the second conveyor.

10. The image reading device according to claim 1, wherein the image reader includes a spectrophotometer.

11. An image forming system comprising:
an image forming apparatus that forms an image on the sheet; and
the image reading device according to claim 1 that is arranged on the downstream side in the sheet conveyance direction with respect to the image forming apparatus.

12. The image forming system according to claim 11, wherein the image forming apparatus forms, on the sheet, two dimensionally arranged adjustment images as the image information.

13. A non-transitory computer-readable storage medium storing a program that is executed on a computer of an image reading device that reads image information of a sheet after image formation, the device including, an image reader that is configured to be capable of moving in a sheet width direction orthogonal to a sheet conveyance direction and to read the image information of the sheet, a first conveyor that is provided on an upstream side of the image reader in the sheet conveyance direction and conveys the sheet, and a second conveyor that is provided on a downstream side of the image reader in the sheet conveyance direction and conveys the sheet, wherein the program is configured to control the computer to perform,
in switching from a convey state in which the first conveyor and the second conveyor cooperate to convey a same sheet to a stopped state in conveyance of the sheet, stopping the first conveyor and then stopping the second conveyor.
